(19) United States
(12) Patent Application Publication
(10) Pub. No.: US 2011/0165810 A1
(43) Pub. Date: Jul. 7, 2011

(54) FIBER COMPOSITE AND METHOD FOR MANUFACTURING THE SAME

(76) Inventors: Masayuki Mori, Osaka-shi (JP); Kazushige Yamamoto, Izumi-shi (JP); Kinya Fujita, Izumi-shi (JP)

(21) Appl. No.: 11/886,567

(22) PCT Filed: Apr. 28, 2005
(86) PCT No.: PCT/JP2005/008208

§ 371 Date: May 12, 2009

(51) Int. Cl. B32B 27/12; B29C 47/00

(52) U.S. Cl. 442/396; 442/394; 442/398; 156/244.11

(57) ABSTRACT

The present invention provides a fiber composite which allows control of a wide range of air permeability from low air permeability to high air permeability to be achieved with a small mass per unit area of resin, and to provide a method for manufacturing the same. A film material 2 of a thermoplastic resin having a melt flow rate of 100 to 500 (g/10 minutes) is extruded and welded to a surface of nonwoven fabric 1. Part of the film material 2 is caused to be partly impregnated into the nonwoven fabric 1 at a plurality of fine points where constituting fibers 1a of the nonwoven fabric 1 abut the film material 2 to thereby form crosslinking parts 3 for coupling the nonwoven fabric 1 to the film material 2. In addition, fine through-holes 4 for air permeation are formed in the film material around bases of the crosslinking parts 3 by the impregnation of the film material 2.

### TECHNICAL FIELD

The present invention relates to a fiber composite which is suitable as building interior materials and automobile interior materials and has excellent acoustic absorption properties, and to a method for manufacturing the same.

### BACKGROUND ART

A floor carpet or mat which is laid on the indoor floor of an automobile requires vibration-damping properties, acoustic insulation properties or acoustic absorption properties in addition to the performance normally required as the interior. A conventional floor carpet or mat has attached importance to vibration-damping properties and acoustic insulation properties. For example, the floor carpet has been laminated with an airtight weight layer of a thermoplastic resin under a surface material thereof. Further, in recent years, a demand of weight saving is strong from the viewpoint of energy saving, and as a result, acoustic absorption properties are being increasingly attached importance in place of conventional acoustic insulation properties. As a floor carpet attaching importance to acoustic absorption properties, there is a floor carpet with nonwoven fabric bonded under the surface material thereof via an adhesive resin layer instead of the airtight weight layer. The floor carpets of this type have been widely used for automobiles (refer to Patent Document 1).

Furthermore, the mechanism of acoustic absorption is recently being solved gradually, and attention has been directed not only to simply bonding nonwoven fabric under the surface material of a floor carpet, but also to the air permeability in the thickness direction of the entire carpet after the nonwoven fabric is bonded (refer to Patent Document 2).

An adhesive resin layer for bonding nonwoven fabric is formed by continuously extruding a thermoplastic resin having a melt flow rate of about 1 to 100 (g/10 minutes) from a heated T-die and applying it to the surface of the nonwoven fabric. A surface material is pressure-bonded to the resin layer before the resin layer is cured, thus forming a one-piece floor carpet.
Patent Document 1: Japanese Patent Laid-Open No. 2003-341406
Patent Document 2: Japanese Patent No. 3359645

### DISCLOSURE OF THE INVENTION

### Problems to be Solved by the Invention

Conventional adhesive resin layers require a specified mass per unit area in order to obtain a uniform and sufficient adhesion effect, but the specified mass per unit area is not necessarily compatible with the optimum air permeability. The air permeability of a carpet varies with apparent density, thickness, fineness, and the like of nonwoven fabric, and the presence itself of a conventional adhesive resin layer extremely reduces air permeability. The above-described Patent Document 1 devises to increase air permeability by extruding an adhesive resin from a T-die into the form of a multiple thread-like rows of filaments and applying them to the surface of nonwoven fabric, but the freedom of controlling air permeability is low and the amount of the resin used is relatively large, which limits the weight saving. In order to provide both weight saving and acoustic absorption properties, it is necessary to allow free control of air permeability to be achieved with a small resin mass per unit area, which could not be achieved by conventional adhesive resin layers.

The present invention has been achieved for solving the above problem. It is an object of the present invention to provide a fiber composite which allows control of a wide range of air permeability from low air permeability to high air permeability to be achieved with a small resin mass per unit area, and to provide a method for manufacturing the same.

### Means for Solving the Problems

In order to solve the above-described problem, the invention of claim 1 is characterized in that a film material of a thermoplastic resin having a melt flow rate (MFR) of 100 to 500 (g/10 minutes) is extruded and welded to a surface of nonwoven fabric to cause part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material.

A thermoplastic resin having high MFR as claim 1 could not be used at all as a fiber composite for automobile carpets (refer to description in [0011] of Patent Document 1). However, the present inventors have found that a large number of fine through-holes naturally formed in a film material when the film material is extruded and welded to nonwoven fabric are very effective to control air permeability of a fiber composite. This finding has led the present inventors to complete the present invention.

Specifically, when a film material of a thermoplastic resin having a high MFR of 100 to 500 is extruded and welded to nonwoven fabric, part of the film material is impregnated into constituting fibers of the nonwoven fabric at the part of the constituting fibers with which the film material is brought into contact by the surface tension of the film material itself. As a result, crosslinking parts for coupling the film material to the nonwoven fabric are formed and the resin in an amount corresponding to the resin impregnated into the constituting fibers is absorbed from the film material, resulting in formation of air permeable fine through-holes in the film material around bases of the crosslinking parts. As a result of formation of a large number of fine through-holes in the film material, air permeability is induced in the fiber composite. Note that the amount of the fine through-holes, in turn air permeability, can be finely controlled by controlling the apparent density or fineness of the nonwoven fabric.

Further, the invention of claim 2 is characterized in that nonwoven fabric and a surface material are welded through a film material of a thermoplastic resin having a melt flow rate of 100 to 500 (g/10 minutes) to cause part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material.

In this claim 2 invention, a surface material is added to the invention of claim 1, and the film material not only acts as an air permeability controlling material but also acts as an adhesive layer to bond between the nonwoven fabric and the surface material. The invention of claim 2 can be applied to carpets in general.

Further, the invention of claim 3 is, in the invention of claim 1 or 2, characterized in that the nonwoven fabric has an apparent density of 0.01 to 0.5 (g/cm³). When the apparent density is less than 0.01 (g/cm³), it is impossible to control air permeability because most of the thermoplastic resin flows down to the nonwoven fabric side and the film material cannot be formed. On the other hand, when the apparent density is more than 0.5 (g/cm³), it is impossible to obtain acoustic absorption properties because substantially no fine through-holes are formed, leading to substantially zero air permeability. Note that a fineness of the nonwoven fabric of 1 to 30 (dtex) provides a suitable resin impregnation and an air permeability range that is suitable for acoustic absorption properties. Further, the thickness of the nonwoven fabric is preferably from 1 to 15 (mm) in terms of smooth manufacture of the fiber composite.

Further, the invention of claim 4 is, in the invention of claim 1 or 2, characterized in that the thermoplastic resin is an ethylene-acrylic copolymer, an ethylene-vinyl acetate copolymer, or a polyolefin copolymer, or any mixture thereof.

Further, the invention of claim 5 is, in the invention of claim 1 or 2, characterized in that the mass per unit area of the thermoplastic resin is 50 to 1,000 (g/m²).

When the mass per unit area of the thermoplastic resin is 50 (g/m²) or less, the film material cannot be substantially formed. On the other hand, when the mass per unit area of the thermoplastic resin is 1,000 (g/m²) or more, the fine through-holes are filled with resin to substantially lose air permeability and acoustic absorption properties. Therefore, the mass per unit area of the thermoplastic resin needs to be from 50 to 1,000 (g/m²).

Further, the invention of claim 6 is, in the invention of claim 1 or 2, characterized in that the air permeability in the thickness direction of the fiber composite is from 1 to 50 (cc/cm²·second).

Further, the invention of the manufacturing method of claim 7 is characterized by extruding and welding a film material of a thermoplastic resin having a melt flow rate of 100 to 500 (g/10 minutes) to a surface of nonwoven fabric at a mass per unit area of the film material of 50 to 1,000 (g/m²), causing part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material.

Further, the invention of the manufacturing method of claim 8 is characterized by welding nonwoven fabric and a surface material through a film material of a thermoplastic resin having a melt flow rate of 100 to 500 (g/10 minutes) and a mass per unit area of 50 to 1,000 (g/m²) to a surface of nonwoven fabric, causing part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material.

Further, the invention of claim 9 is, in the invention of claim 7 or 8, characterized in that the nonwoven fabric has an apparent density of 0.01 to 0.5 (g/cm³).

When the apparent density is less than 0.01 (g/cm³), most of the thermoplastic resin flows down to the nonwoven fabric side and the film material cannot be formed. When the apparent density is more than 0.5 (g/cm³), it is impossible to obtain acoustic absorption properties because substantially no fine through-holes are formed, leading to substantially zero air permeability. Note that the fineness of the nonwoven fabric of 1 to 30 (dtex) provides a suitable resin impregnation. Further, the thickness of the nonwoven fabric is preferably from 1 to 15 (mm) in terms of smooth manufacture of the fiber composite.

Further, the invention of claim 10 is, in the invention of claim 7 or 8, characterized in that the thermoplastic resin is an ethylene-acrylic copolymer, an ethylene-vinyl acetate copolymer, or a polyolefin copolymer, or any mixture thereof.

### ADVANTAGES OF THE INVENTION

According to the present invention, a film material of a thermoplastic resin having a melt flow rate of 100 to 500 (g/10 minutes) is extruded and welded to a surface of nonwoven fabric to cause part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material. Therefore, the amount of the crosslinking parts or fine through-holes to be formed, in turn air permeability, can be controlled in a wide range even when the amount of the film material to be used is small, by controlling the melt flow rate within the above-described range and controlling the apparent density and fineness of the nonwoven fabric. As a result, a fiber composite having high acoustic absorption properties can be achieved.

### BRIEF DESCRIPTION OF THE DRAWINGS

FIG. 1 is a sectional view of a fiber composite of the present invention;

FIG. 2 is a partly enlarged sectional view of a fiber composite of the present invention;

FIG. 3 is a sectional view of another fiber composite of the present invention;

FIG. 4 is a table showing air permeability for thermoplastic resins each having a different MFR of the fiber composite of the present invention; and

FIG. 5 is a graphic representation of the table of FIG. 4.

### DESCRIPTION OF SYMBOLS

1 Nonwoven fabric
1a Constituting fiber
2 Film material
3 Crosslinking part
4 Fine through-hole
5 Surface material

### BEST MODE FOR CARRYING OUT THE INVENTION

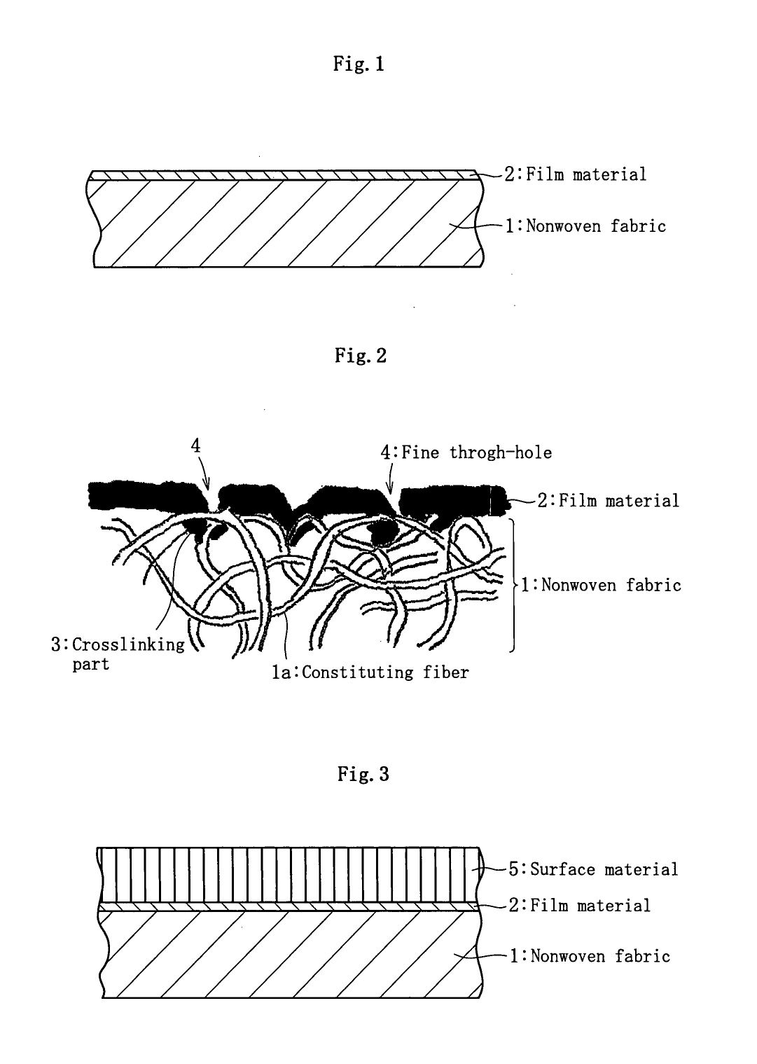

An embodiment of the present invention will hereafter be described with reference to FIGS. 1 to 5. As shown in FIG. 1, a fiber composite of the present invention comprises nonwoven fabric 1 and a film material 2. Materials and methods for manufacturing the nonwoven fabric 1 are not particularly limited. Any nonwoven fabric prepared from any material by using any production method can be used. For example, wet or dry nonwoven fabric prepared by using chemical bonding, thermal bonding, needle punching, or stitch bonding can be used, and spunbonded nonwoven fabric, melt blow nonwoven fabric, flash spinning nonwoven fabric, and the like can also be used.

The film material 2 is prepared by extruding a thermoplastic resin having a melt flow rate (MFR) of 100 to 500 (g/10 minutes) from a heated T-die in a sheet form. For example, the film material is extruded in a downward direction from a T-die in a sheet form, and immediately after the extrusion it is welded to the surface of the nonwoven fabric 1. An ethylene-acrylic copolymer, an ethylene-vinyl acetate copolymer, or a polyolefin copolymer can be used singly, or any mixture thereof can be used, as a thermoplastic resin for use in the film material.

When a sheet-form thermoplastic resin is extruded and welded to the nonwoven fabric 1, the thermoplastic resin is partly impregnated into constituting fibers of the nonwoven fabric 1 at a plurality of fine points by the surface tension or capillarity of the thermoplastic resin itself, as shown in FIG. 2. As a result, the resin of the film material 2 in an amount corresponding to the resin impregnated from the film material 2 is absorbed to thereby form fine through-holes 4 for air permeation in the film material 2. On the other hand, crosslinking parts 3 for coupling the nonwoven fabric 1 to the film material 2 are formed by the resin impregnated around the constituting fibers 1a.

Next, an embodiment in which the present invention is applied to a carpet will be described with reference to FIG. 3. In this embodiment, a surface material 5 is disposed on the film material 2 of FIG. 1. According to applications, any surface material can be used as a surface material, such as nonwoven fabric, knitted fabric (pile knitted fabric, and plain knitted fabric) and woven fabric (single layer fabric, multiple fabric, pile fabric, leno weaving fabric, twill fabric, and lace fabric). The film material 2 is welded to the surface of the nonwoven fabric 1 and to the back surface of the surface material 5 to thereby combine the both, and fine through-holes 4 formed in the film material 2 in the same manner as in FIG. 2 provide air permeability or acoustic absorption properties. Moreover, the air permeability can be decreased by appropriately applying pressure to the surface material 5 toward the film material 2 before the film material 2 is cooled and hardened, because the size and number of the fine through-holes 4 are decreased mainly by the application of pressure.

When a fiber composite in FIG. 3 is manufactured, a sheet-form thermoplastic resin is continuously extruded in a downward direction from a heated T-die, and the nonwoven fabric 1 and the surface material 5 are continuously supplied from both sides of the sheet-form thermoplastic resin such that one of them runs parallel with one side of the thermoplastic resin and the other runs parallel with the other side of the thermoplastic resin. An ethylene-acrylic copolymer, an ethylene-vinyl acetate copolymer, or a polyolefin copolymer can be used singly, or any mixture thereof can be used, as a thermoplastic resin for use in the film material 2.

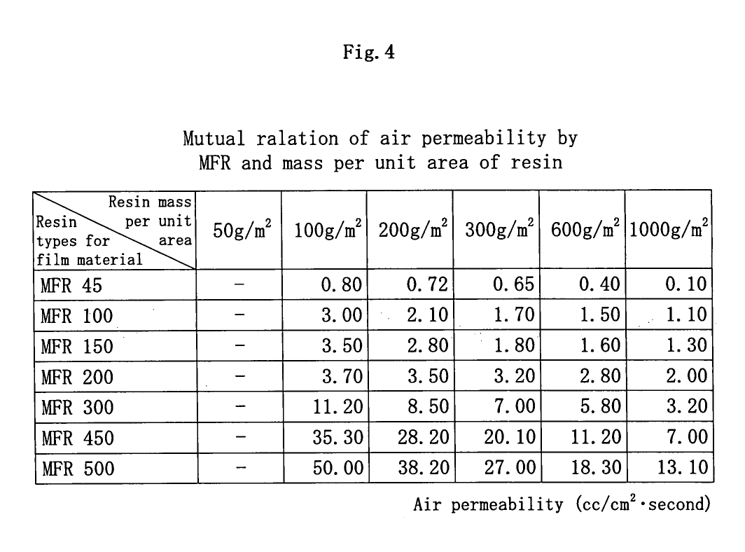

Air permeability for thermoplastic resins each having a different MFR value is shown in FIG. 4 as the Example of the fiber composite of the present invention. An ethylene-methacrylic copolymer was used as a thermoplastic resin. The nonwoven fabric to which this thermoplastic resin is welded has a fineness of 6 (dtex) and a mass per unit area of 300 (g/m²). In the column, there are shown seven types of thermoplastic resins each having a different MFR of from 45 to 500. In the row, there are shown six types of thermoplastic resins each having a mass per unit area of from 50 (g/m²) to 1,000 (g/m²). The indication “-” for the mass per unit area of 50 (g/m²) shows that the mass per unit area of 50 (g/m²) is too small to form the film material 2, thereby making it impossible to measure air permeability. The unit of air permeability is (cc/cm²·second). As described herein, the value of “air permeability” is a value measured in accordance with the method according to 827.1 A of JIS (Japanese Industrial Standard) L 1096-1999.

From FIG. 4, it is apparent that, by combining various values of MFR and mass per unit area, air permeability can be controlled in a wide range from a high air permeability of 50.00 (cc/cm²·second) of the thermoplastic resin having an MFR of 500 and a mass per unit area of 100 g/m² to a low air permeability of 1.10 (cc/cm²·second) of the thermoplastic resin having an MFR of 100 and a mass per unit area of 1,000 g/m². The air permeability range of from 1 to 50 (cc/cm²·second) is a range effective for exhibiting acoustic absorption effect, and in particular, a range satisfying the acoustic absorption properties required for a floor carpet for automobiles. Note that when MFR exceeds 500 (g/10 minutes), it is impossible to control air permeability because the film material 2 cannot be formed. Further, when MFR is less than 100 (g/10 minutes), air permeability is substantially “zero” even if mass per unit area is reduced to 50 (g/m²), and it is apparent that a fiber composite having acoustic absorption properties cannot be prepared.

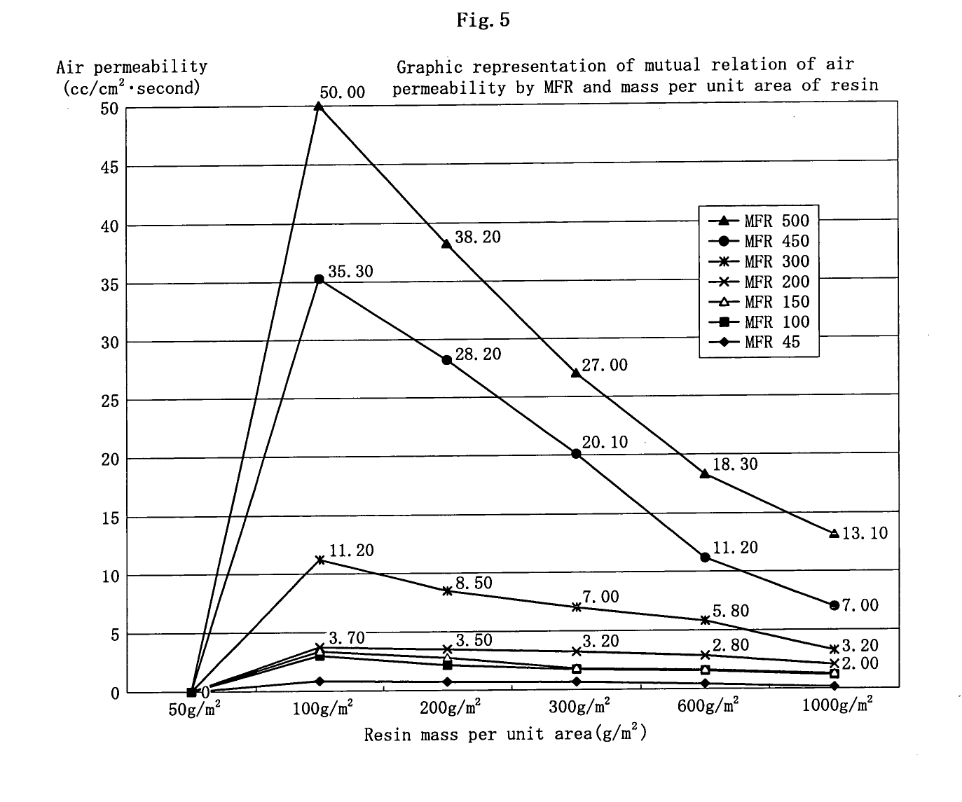

FIG. 5, which is a graphic representation of the data in FIG. 4, shows the situation of the above-described wide range of distribution of air permeability. On the basis of these data, a specified air permeability required for a fiber composite for a specific application can be easily embodied by only selecting corresponding MFR and mass per unit area of a thermoplastic resin.

While the present invention has hereinbefore been described with reference to an embodiment of the present invention, it should be understood that various modifications may be made on the basis of technical principles described in the claims without being limited to the embodiment of the present invention as described above.

1. A fiber composite, characterized in that a film material of a thermoplastic resin having a melt flow rate of 100 to 500 (g/10 minutes) is extruded and welded to a surface of nonwoven fabric to cause part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material.

2. A fiber composite, characterized in that nonwoven fabric and a surface material are welded through a film material of a thermoplastic resin having a melt flow rate of 100 to 500 (g/10 minutes) to cause part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material.

3. The fiber composite according to claim 1 or 2, characterized in that the nonwoven fabric has an apparent density of 0.01 to 0.5 (g/cm³).

4. The fiber composite according to claim 1 or 2, characterized in that the thermoplastic resin is an ethylene-acrylic copolymer, an ethylene-vinyl acetate copolymer, or a polyolefin copolymer, or any mixture thereof.

5. The fiber composite according to claim 1 or 2, characterized in that the mass per unit area of the thermoplastic resin is 50 to 1,000 (g/m²).

6. The fiber composite according to claim 1 or 2, characterized in that the air permeability in the thickness direction is from 1 to 50 (cc/cm²·second).

7. A method for manufacturing a fiber composite, characterized by extruding and welding a film material of a thermoplastic resin having a melt flow rate of 100 to 500 (g/10 minutes) to a surface of nonwoven fabric at a mass per unit area of the film material of 50 to 1,000 (g/m²) and causing part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material.

8. A method for manufacturing a fiber composite, characterized by welding nonwoven fabric and a surface material through a film material of a thermoplastic resin having a melt flow rate of 100 to 500 (g/10 minutes) and a mass per unit area of 50 to 1,000 (g/m²) to a surface of nonwoven fabric and causing part of the film material to be partly impregnated into the nonwoven fabric at a plurality of fine points where constituting fibers of the nonwoven fabric abut the film material to thereby form crosslinking parts for coupling the nonwoven fabric to the film material, wherein fine through-holes for air permeation are formed in the film material around bases of the crosslinking parts by the impregnation of the film material.

9. The method for manufacturing a fiber composite according to claim 7 or 8, characterized in that the nonwoven fabric has an apparent density of 0.01 to 0.5 (g/cm³).

10. The method for manufacturing a fiber composite according to claim 7 or 8, characterized in that the thermoplastic resin is an ethylene-acrylic copolymer, an ethylene-vinyl acetate copolymer, or a polyolefin copolymer, or any mixture thereof.
